(19) United States
(12) Patent Application Publication
(10) Pub. No.: US 2015/0356484 A1
(43) Pub. Date: Dec. 10, 2015

(54) METHODS, SYSTEMS, AND APPARATUS FOR FEEDBACK-DRIVEN ITEM AVAILABILITY

(71) Applicants: Lakshmanan Velusamy, Bellevue, WA (US); Suriya Prakash Kalivardhan, Bellvue, WA (US); Farah Mariam Ali, Bellevue, WA (US)

(72) Inventors: Lakshmanan Velusamy, Bellevue, WA (US); Suriya Prakash Kalivardhan, Bellvue, WA (US); Farah Mariam Ali, Bellevue, WA (US)

(21) Appl. No.: 14/298,213

(22) Filed: Jun. 6, 2014

(51) Int. Cl. G06Q 10/06; G06Q 10/08; G06Q 30/02

(52) U.S. Cl. CPC G06Q 10/06315; G06Q 30/0202; G06Q 10/087

(57) ABSTRACT

Methods, systems, and apparatus for controlling an inventory of an item for sale are described. A demand for the item and an inventory of the item are projected. A recommended future time period for listing the item for sale is determined based on the projected demand and the projected inventory and is provided to a user listing the item on an online marketplace. A user-selected listing time period is obtained and an item record generated comprising an item description, the item record being associated with the user-selected listing time period.

### TECHNICAL FIELD

The present application relates generally to electronic commerce, and more specifically, in one example, to controlling an available inventory of an item for sale.

### BACKGROUND

Consumers are shopping online for a growing variety of products and services and may conduct searches to locate items that are available for purchase. The consumers of products and services may generally include retail consumers, distributors, small business owners, business representatives, corporate representatives, non-profit organizations, and the like. The providers of the products and/or services may include individuals, retailers, wholesalers, distributors, manufacturers, service providers, small business owners, independent dealers, and the like. The listing for an item that is available for purchase may comprise a price, a description of the product and/or service and, optionally, one or more specific terms for the offer.

Searches by consumers for particular products and/or services are often thwarted by a lack of availability of the desired product and/or service, and sellers may fail to sell or obtain an optimal price for an item due to the time period selected for selling an item.

### BRIEF DESCRIPTION OF THE DRAWINGS

Some embodiments are illustrated by way of example and not limitation in the figures of the accompanying drawings in which:

FIG. 1A is a network diagram depicting a client-server system, within which one example embodiment may be deployed;

FIG. 1B is a block diagram illustrating marketplace and payment applications that, in one example embodiment, are provided as part of application server(s) in the networked system;

FIG. 1C shows a block diagram of an example system for controlling an available inventory of an item for sale, in accordance with an example embodiment;

FIG. 2 shows a flowchart for an example electronic commerce method for listing, indexing, and searching for a product and/or service, in accordance with an example embodiment;

FIG. 3 shows a block diagram of an example system for initiating and conducting a search for products and/or services, in accordance with an example embodiment;

FIG. 4 shows a representation of an example user interface for performing a search for a product and/or service, in accordance with an example embodiment;

FIG. 5 shows a flowchart for an example user interface method, in accordance with an example embodiment;

FIG. 6 shows a block diagram of an example apparatus for controlling an available inventory of an item for sale, in accordance with an example embodiment;

FIGS. 7A and 7B show example data structures for generating and maintaining historical demand data for an item, in accordance with an example embodiment;

FIGS. 8A and 8B show example data structures for generating and maintaining historical inventory data for an item, in accordance with an example embodiment;

FIG. 9 shows an example data structure for generating and maintaining scheduled inventory data for an item for sale, in accordance with an example embodiment;

FIG. 10 shows an example data structure for generating and maintaining projected demand data for an item, in accordance with an example embodiment;

FIG. 11 shows an example data structure for generating and maintaining projected inventory data for an item, in accordance with an example embodiment;

FIG. 12 shows an example data structure for generating and maintaining projected oversupply/shortage data for an item, in accordance with an example embodiment;

FIG. 13 shows a flowchart for an example method for controlling an available inventory of an item for sale, in accordance with an example embodiment;

FIG. 14 shows a flowchart for an example method for projecting demand data for an item, in accordance with an example embodiment;

FIG. 15 shows a flowchart for an example method for projecting inventory data for an item, in accordance with an example embodiment;

FIG. 16 shows a flowchart for an example method for projecting an oversupply/shortage of an item, in accordance with an example embodiment;

FIG. 17 shows a flowchart for an example method for determining a recommended time period for listing an item for sale, in accordance with an example embodiment;

FIG. 18 shows a flowchart for an example method for updating scheduled inventory data for an item, in accordance with an example embodiment;

FIG. 19 shows a flowchart for an example method for updating the historical demand of an item for sale, in accordance with an example embodiment;

FIG. 20 shows a representation of an example user interface for listing a product and/or service, in accordance with an example embodiment;

FIG. 21 is a block diagram of machine within which instructions may be executed for causing the machine to perform any one or more of the methodologies discussed herein; and

FIG. 22 is a block diagram illustrating a mobile device, according to an example embodiment.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for controlling an available inventory of an item for sale are described. In one example embodiment, the control is based on analyzing data that characterizes a demand for and/or inventory of the item. The demand may be based, for example, on consumer demand and may be determined by tracking consumer interest in the item. In one example embodiment, demand is projected for a future time period based on, for example, a historical demand for an item and a current demand for the item. Demand can also be predicted based upon current demand data, historical demand data, upcoming events (e.g., a holiday), an introduction of a new version of the item(s), and the like.

In one example embodiment, inventory is projected for a future time period based on, for example, a historical inventory of an item and a current inventory for the item.

In one example embodiment, the inventory may be adjusted by recommending, to a seller, a preferred time period for the seller to list the item for sale. The recommended time period may correspond to a time when the projected demand for the item exceeds the projected supply, when a projected price for an item exceeds a specific level, and the like. As used herein, an “item” may refer to a product and/or a service.

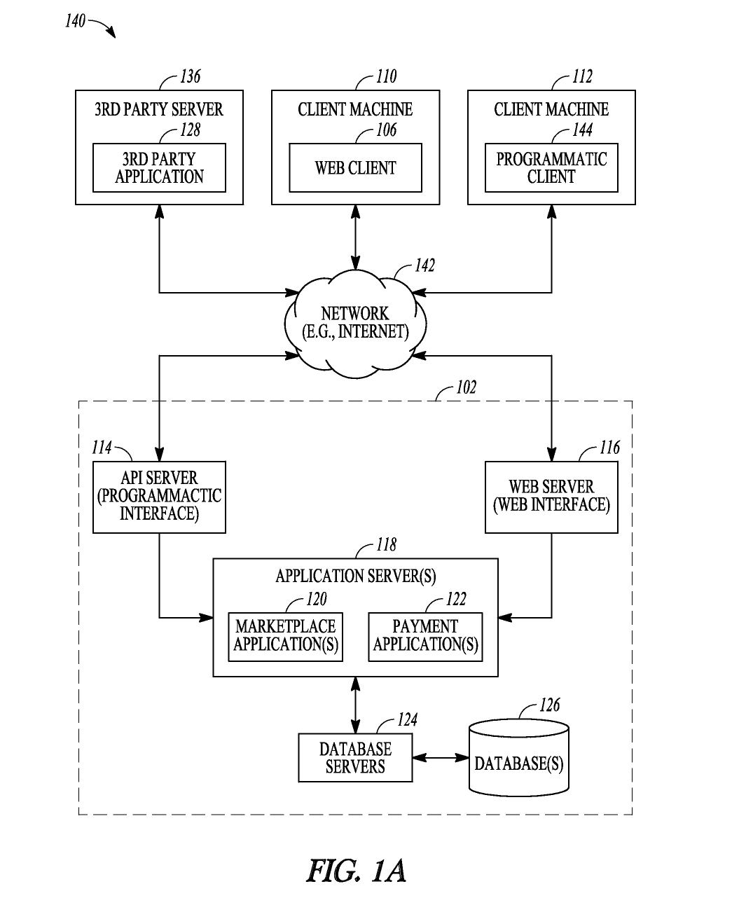

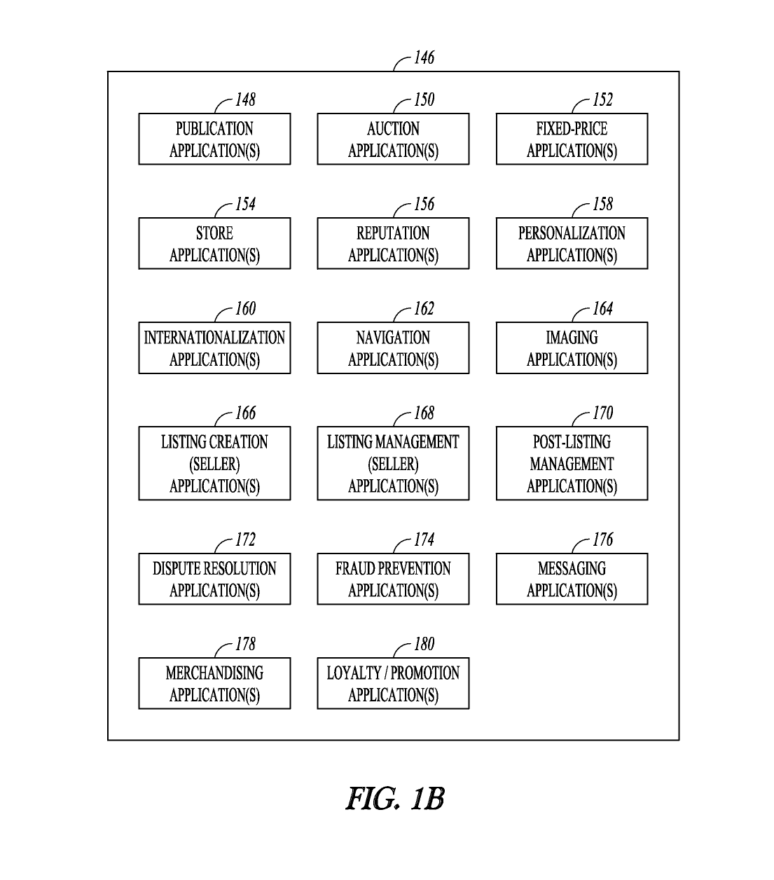

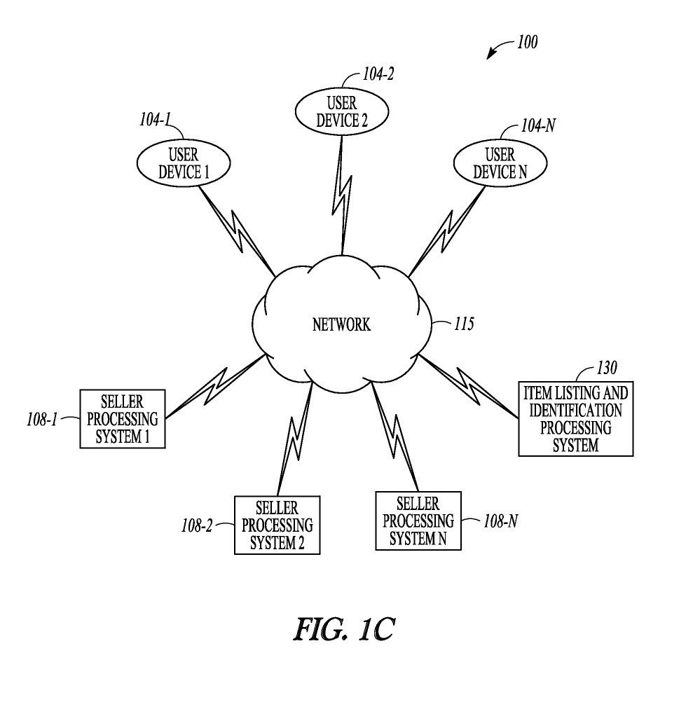

FIG. 1A is a network diagram depicting a client-server system 140, within which one example embodiment may be deployed. A networked system 102, in the example forms of a network-based marketplace or publication system, provides server-side functionality, via a network 142 (e.g., the Internet or a Wide Area Network (WAN)), to one or more clients. FIG. 1A illustrates, for example, a web client 106 (e.g., a browser, such as the Internet Explorer® browser developed by Microsoft® Corporation of Redmond, Wash. State) and a programmatic client 144 executing on respective devices 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1A to both form part of the networked system 102, it will be appreciated that, in alternative embodiments, the payment applications 122 may form part of a payment service that is separate and distinct from the networked system 102.

Further, while the system 140 shown in FIG. 1A employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 144 accesses the various services and functions provided by the marketplace and payment applications 120 and 122 via the programmatic interface provided by the API server 114. The programmatic client 144 may, for example, be a seller application (e.g., the Turbo Lister application developed by eBay Inc., of San Jose, Calif. ) to enable sellers to author and manage listings on the networked system 102 in an offline manner, and to perform batch-mode communications between the programmatic client 144 and the networked system 102.

FIG. 1A also illustrates a third party application 128, executing on a third party server machine 136, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 1B is a block diagram illustrating marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 148 and one or more auction applications 150, which support auction-format listing and price setting mechanisms (e.g., English, Dutch, Vickrey, Chinese, Double, Reverse auctions, etc.). The various auction applications 150 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 152 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif. ) may be offered in conjunction with auction-format listings, and allow a buyer to purchase goods or services, which are also being offered for sale via an auction, for a fixed-price that is typically higher than the starting price of the auction.

Store applications 154 allow a seller to group listings within a “virtual” store, which may be branded and otherwise personalized by and for the seller. Such a virtual store may also offer promotions, incentives, and features that are specific and personalized to a relevant seller.

Reputation applications 156 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 156 allow a user (for example, through feedback provided by other transaction partners) to establish a reputation within the networked system 102 over time. Other potential trading partners may then reference such a reputation for the purposes of assessing credibility and trustworthiness.

Personalization applications 158 allow users of the networked system 102 to personalize various aspects of their interactions with the networked system 102. For example a user may, utilizing an appropriate personalization application 158, create a personalized reference page at which information regarding transactions to which the user is (or has been) a party may be viewed. Further, a personalization application 158 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 160 that customize information (and/or the presentation of information by the networked system 102) according to predetermined criteria (e.g., geographic, demographic or marketplace criteria). For example, the internationalization applications 160 may be used to support the customization of information for a number of regional websites that are operated by the networked system 102 and that are accessible via respective web servers 116.

Navigation of the networked system 102 may be facilitated by one or more navigation applications 162. For example, a search application (as an example of a navigation application 162) may enable key word searches of listings published via the networked system 102. A browse application may allow users to browse various category, catalogue, or inventory data structures according to which listings may be classified within the networked system 102. Various other navigation applications 162 may be provided to supplement the search and browsing applications.

In order to make listings available via the networked system 102 as visually informing and attractive as possible, the applications 120 and 122 may include one or more imaging applications 164, which users may utilize to upload images for inclusion within listings. An imaging application 164 also operates to incorporate images within viewed listings. The imaging applications 164 may also support one or more promotional features, such as image galleries that are presented to potential buyers. For example, sellers may pay an additional fee to have an image included within a gallery of images for promoted items.

Listing creation applications 166 allow sellers to conveniently author listings pertaining to goods or services that they wish to transact via the networked system 102, and listing management applications 168 allow sellers to manage such listings. Specifically, where a particular seller has authored and/or published a large number of listings, the management of such listings may present a challenge. The listing management applications 168 provide a number of features (e.g., auto-relisting, inventory level monitors, etc.) to assist the seller in managing such listings. One or more post-listing management applications 170 also assist sellers with a number of activities that typically occur post-listing. For example, upon completion of an auction facilitated by one or more auction applications 150, a seller may wish to leave feedback regarding a particular buyer. To this end, a post-listing management application 170 may provide an interface to one or more reputation applications 156, so as to allow the seller conveniently to provide feedback regarding multiple buyers to the reputation applications 156.

Dispute resolution applications 172 provide mechanisms whereby disputes arising between transacting parties may be resolved. For example, the dispute resolution applications 172 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 174 implement fraud detection and prevention mechanisms to reduce the occurrence of fraud within the networked system 102.

Messaging applications 176 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 176 may utilize any one of a number of message delivery networks and platforms to deliver messages to users. For example, messaging applications 176 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 142.

Merchandising applications 178 support various merchandising functions that are made available to sellers to enable sellers to increase sales via the networked system 102. The merchandising applications 178 also operate the various merchandising features that may be invoked by sellers, and may monitor and track the success of merchandising strategies employed by sellers. The networked system 102 itself, or one or more parties that transact via the networked system 102, may operate loyalty programs that are supported by one or more loyalty/promotions applications 180. For example, a buyer may earn loyalty or promotion points for each transaction established and/or concluded with a particular seller, and be offered a reward for which accumulated loyalty points can be redeemed.

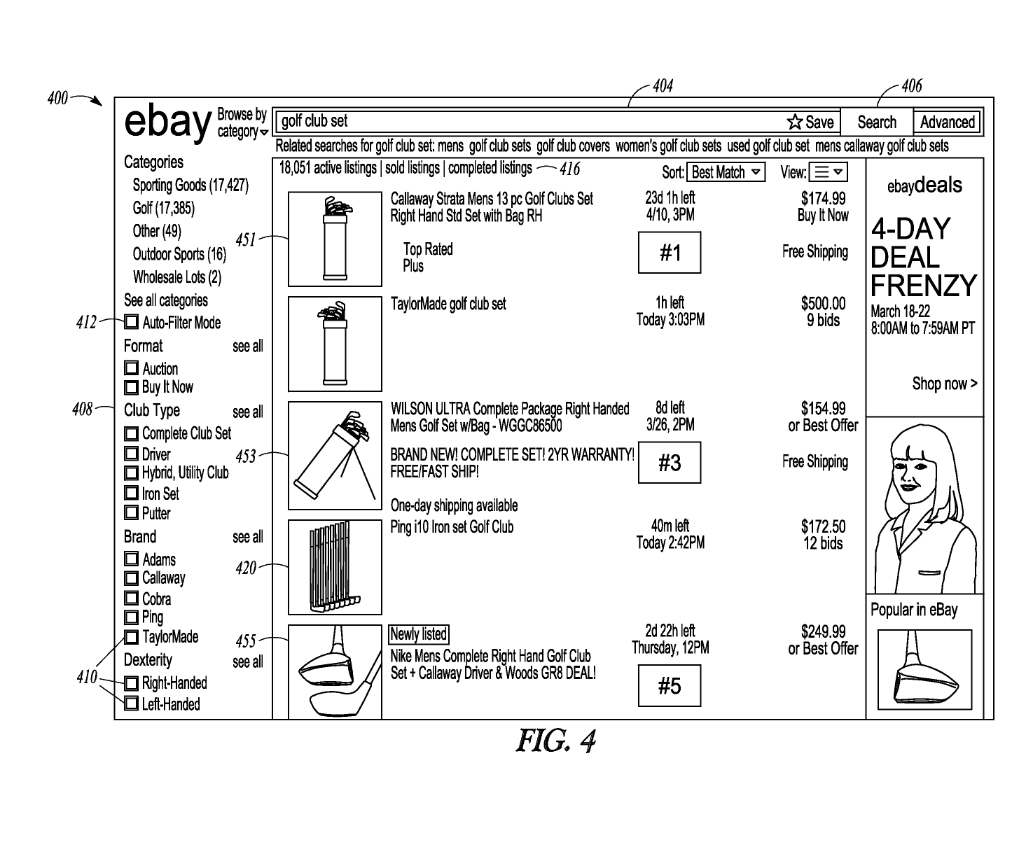

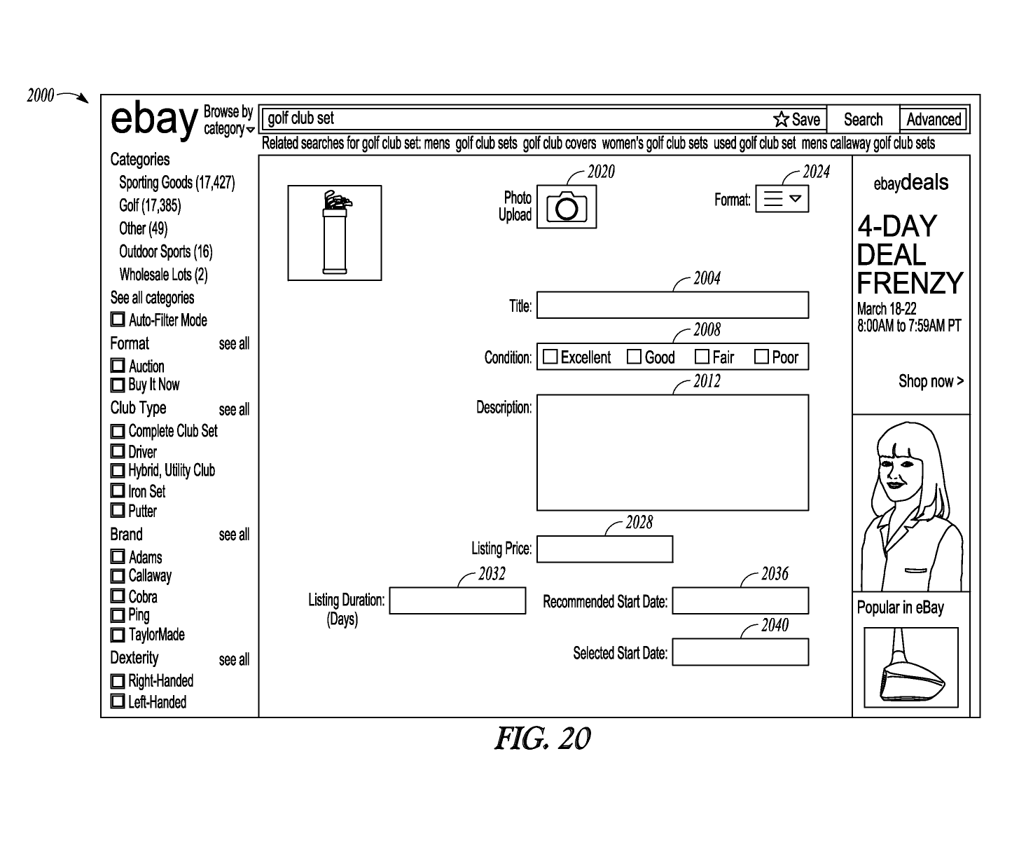

FIG. 1C shows a block diagram of an example system 100 for controlling an available inventory of an item for sale, in accordance with an example embodiment. In one example embodiment, the system 100 may comprise one or more user devices 104-1, 104-2 and 104-N (known as user devices 104 hereinafter), one or more optional seller processing systems 108-1, 108-2 and 108-N (known as seller processing systems 108 hereinafter), an item listing and identification processing system 130, and a network 115. Each user device (e.g., 104-1) may be a personal computer (PC), a mobile phone, a personal digital assistant (PDA), or any other appropriate computer device. Each user device (104-1, 104-2 or 104-N) may include a user interface module 306, described more fully below in conjunction with FIGS. 4 and 20. In one example embodiment, the user interface module 306 may comprise a web browser program. Although a detailed description is only illustrated for user device 104-1, it is noted that each of the other user devices (e.g., user device 104-2 through user device 104-N) may have corresponding elements with the same functionality.

The optional seller processing systems 108 and the item listing and identification processing system 130 may be a server, client, or other processing device that includes an operating system for executing software instructions. The optional seller processing systems 108 may provide items for sale to a consumer, and may facilitate the search for and purchase of the items to a variety of consumers.

The network 115 may be a local area network (LAN), a wireless network, a metropolitan area network (MAN), a wide area network (WAN), a wireless network, a network of interconnected networks, the public switched telephone network (PSTN), and the like.

Each user device 104 may receive a query for item information from a user via an input device such as keyboard, mouse, electronic pen, etc. (not shown in FIG. 1). An item may comprise a product and/or a service and the corresponding information may be in the form of an item listing.

The item listing and identification processing system 130 of an online listing system may store and/or obtain information related to items available for sale. Each item listing may comprise a detailed description for the item, a picture of the item, attributes of the item, and the like. The item associated with the item listing may be a good or product (e.g., a tablet computer) and/or a service (e.g., a round of golf or appliance repair) that may be transacted (e.g., exchanging, sharing information about, buying, selling, making a bid on, and the like). The item listing may also include a title, a category (e.g., electronics, sporting goods, books, antiques, and the like), and attributes and tag information (e.g., color, size, and the like).

Referring back to the user device 104-1, the query received from the user of user device 104-1 may comprise one or more keywords. The user device 104-1 may transmit the query to the item listing and identification processing system 130 via the network 115. The item listing and identification processing system 130 may attempt to match the query keywords with the title, the category, the tag information, and/or any other field in the item listing using a search engine and may identify one or more item listings that satisfy the query. The item listing and identification processing system 130 may retrieve and then sort the item listings in the search result in a known manner. The item listing and identification processing system 130 may return a sorted search result list to the user device 104 that submitted the query.

The search result list may comprise a list of available items of varying degrees of relevance to the particular product or product type for which the consumer is searching. The consumer may select from the search result list one or more items that correspond more closely to the consumer's search intention, e.g., in order to obtain additional information on the item and/or the consumer may apply one or more filters and may resubmit the query.

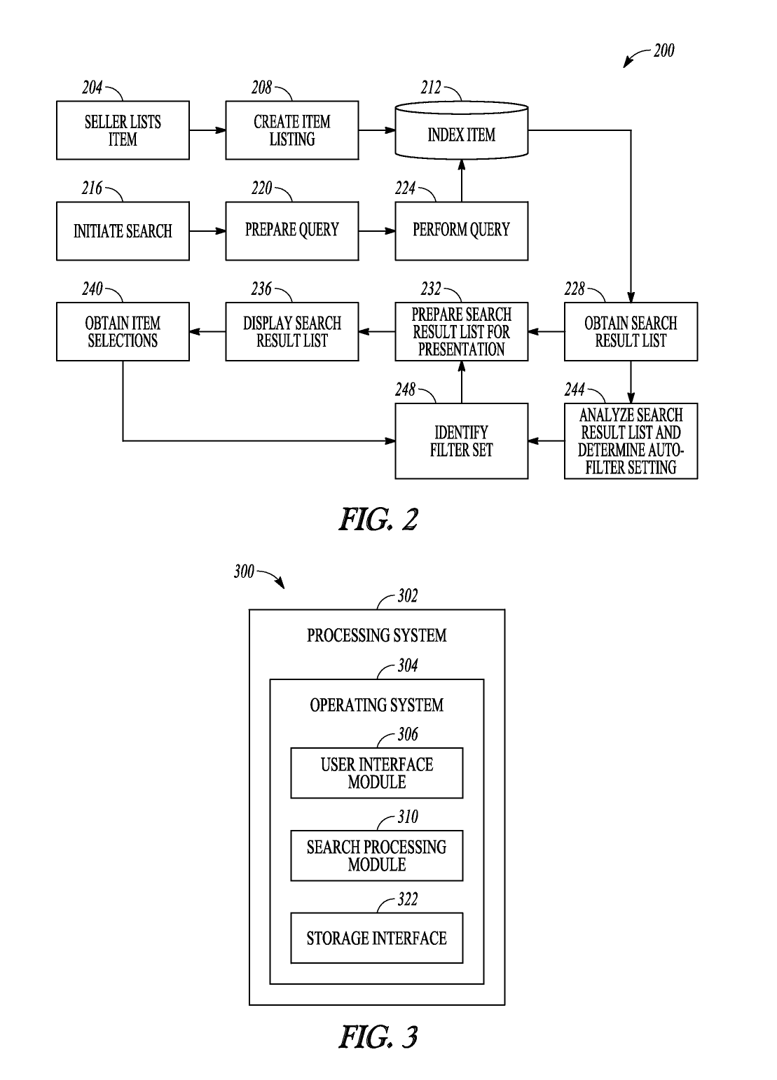

FIG. 2 shows a flowchart for an example electronic commerce method 200 for listing, indexing, and searching for a product and/or service, in accordance with an example embodiment. In one example embodiment, a seller may list an item for sale (operation 204). The seller may, for example, select a category for the item, submit a description of the item, submit a picture of the item, manually set attributes of the item, and the like.

An item listing may be created in, for example, an item listing database (operation 208). The listing may include, for example, attributes of the item and terms of the sale offer. During the item listing operation 208, an identification number for the item listing may be assigned, and the listing may be authenticated and scanned to check for conformance with one or more listing policies. The listed item may be indexed (operation 212) in a known manner to facilitate future searches for the item.

A consumer may launch a search or query for one or more items (operation 216). For example, a consumer may initiate a search using the keywords “golf clubs.” A corresponding query may be prepared (operation 220). For example, a spell check may be performed on the query terms and a search expression may be generated based on the provided search terms.

The query may be executed on, for example, the items that have been indexed in the system (operation 224). For example, the prepared query may be matched against the index that was updated during operation 212.

In response to the execution of the query, a search result list may be obtained (operation 228). The search result list may be analyzed and an auto-filter mechanism may be enabled or disabled based, for example, on the obtained search result list (operation 244). For example, the auto-filter mechanism may be enabled if the count of items in the search result list exceeds a threshold value and/or if the auto-filter mechanism has been enabled by a user.

The search result list may be prepared for presentation (operation 232). For example, the search result list may be filtered, sorted, ranked and/or formatted based, for example, on the analysis of the search result list performed during operation 244 and based on an identified set of search filters.

The prepared search result list may be displayed (operation 236). In response to reviewing the displayed search result list, one or more item selections from one or more displayed item pages may be obtained from a user (operation 240)

One or more search filters may be identified and enabled (operation 248). The selection of filters may be performed as described herein. For example, the search result list and/or user item selections may be analyzed to determine the filter set.

If a user indicates that a search should be broadened, such as expanding a search for new, right-handed golf clubs to a search for right-handed golf clubs that are new or used, a new query may be conducted.

FIG. 3 shows a block diagram of an example system 300 for initiating and conducting a search for products and/or services, in accordance with an example embodiment. The system 300 is shown to include a processing system 302 that may be implemented on a client or other processing device that includes an operating system 304 for executing software instructions.

In accordance with an example embodiment, the system 300 may include a user interface module 306 and a search processing module 310. In accordance with an example embodiment, the system 300 may further include a storage interface 322.

The user interface module 306 may obtain search criteria from a user (consumer), may present a search result list to a user, and may obtain search filter settings from a user.

The search processing module 310 may submit a query to the item listing and identification processing system 130, may obtain a search result list from the item listing and identification processing system 130, and may obtain search filter settings from the user and/or the item listing and identification processing system 130.

FIG. 4 shows a representation 400 of an example user interface for performing a search for a product and/or service, in accordance with an example embodiment. In one example embodiment, the user interface representation 400 may be utilized by user device 104 to enable a user to conduct a search for an item.

In one example embodiment, one or more keywords may be entered in an input search field 404 and a search button 406 may be selected to initiate the search. The search may be constrained by the search filter settings identified by filter selection indicators 410 in a filter selection area 408. One or more items may be displayed in a search result list area 416. In the example user interface representation 400, the items in the search result list area 416 are a variety of sets of golf clubs. Golf sets 451, 453, 455 are right-handed golf sets; the remaining golf sets (e.g., golf set 420) are left-handed golf sets. In one example embodiment, a user may select one of the golf sets and obtain additional information on the selected golf set.

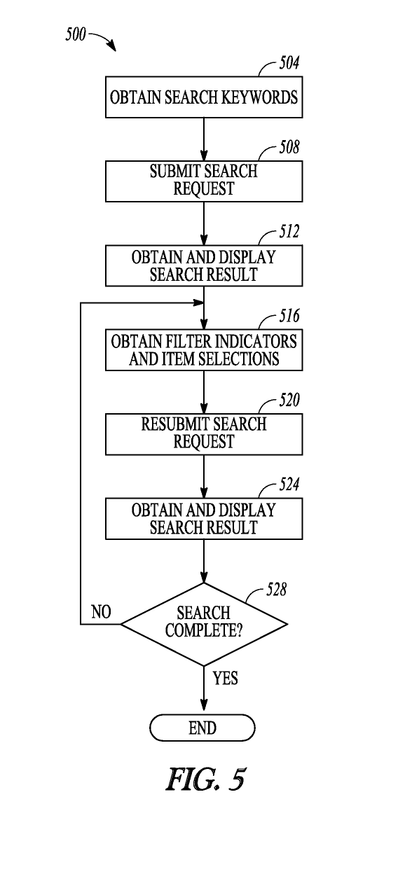

FIG. 5 shows a flowchart for an example user interface method 500, in accordance with an example embodiment. In one example embodiment, one or more of the operations of the user interface method 500 may be performed by the user device 104.

One or more keywords and filter identifications may be obtained from a user initiating a search for a product and/or service by entering the one or more keywords via the input search field 404 (operation 504). The search may be submitted (operation 508) to, for example, the item listing and identification processing system 130. A search result list may be obtained from the item listing and identification processing system 130 and displayed in the search result list area 416 (operation 512).

One or more item selections from the search result list area 416 and/or one or more search filters identified by the filter selection indicators 410 may be obtained (operation 516). The keyword search may be resubmitted to the item and listing identification processing system 130 by selecting the search button 406 (operation 520). An updated search result list may be presented in the search result list area 416. A test may be performed to determine if the search is complete (operation 528). If the search is complete, the method may end.

If the search is not complete, the user may select one or more items from the search result list area 416 and/or may change one or more of the filter selection indicators 410 (operation 516) and the method may proceed with operation 520.

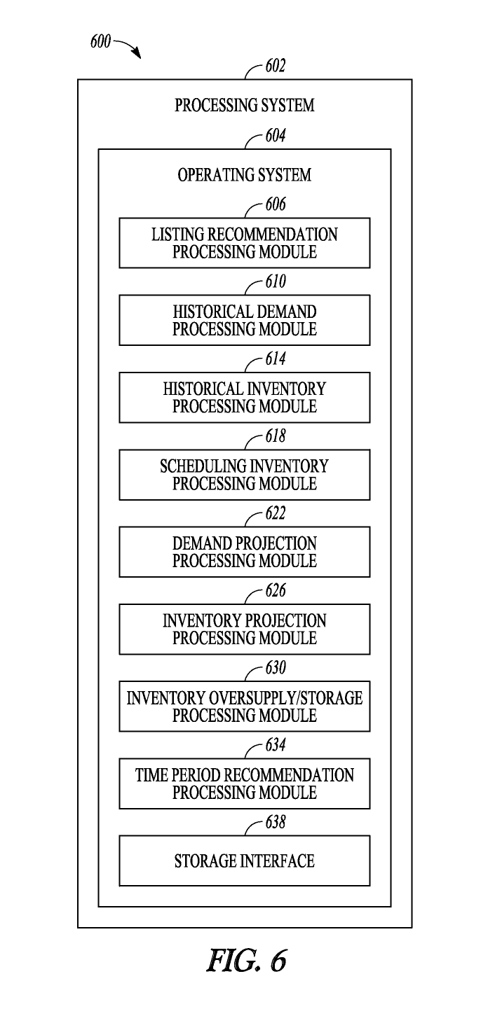

FIG. 6 shows a block diagram of an example apparatus 600 for controlling an available inventory of an item for sale, in accordance with an example embodiment. The apparatus 600 is shown to include a processing system 602 that may be implemented on a client or other processing device that includes an operating system 604 for executing software instructions. In accordance with an example embodiment, the apparatus 600 may include a listing recommendation processing module 606, a historical demand processing module 610, a historical inventory processing module 614, a scheduled inventory processing module 618, a demand projection processing module 622, an inventory projection processing module 626, an inventory oversupply/shortage processing module 630, and a time period recommendation processing module 634. In accordance with an example embodiment, the apparatus 600 may further include a storage interface 638.

The listing recommendation processing module 606 may control an available inventory of an item for sale, may propose a time period for an item listing and, optionally, may propose a suggested price or price range for the item listing. The proposed time period may be based on an inventory oversupply/shortage projection provided by the inventory oversupply/shortage processing module 630.

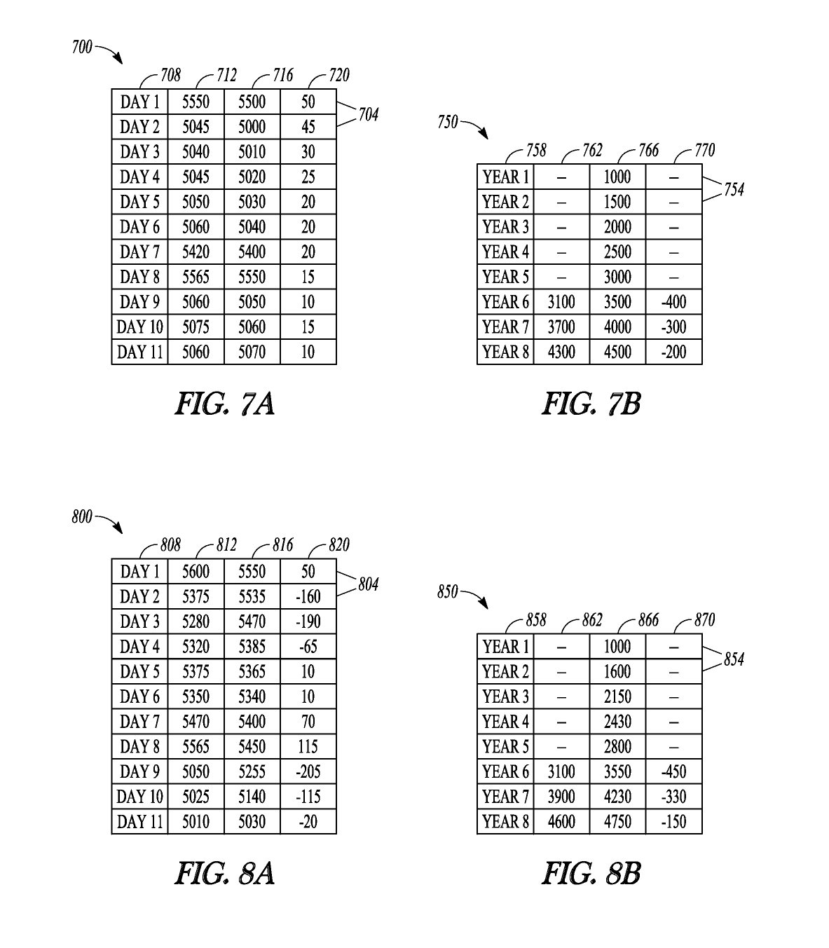

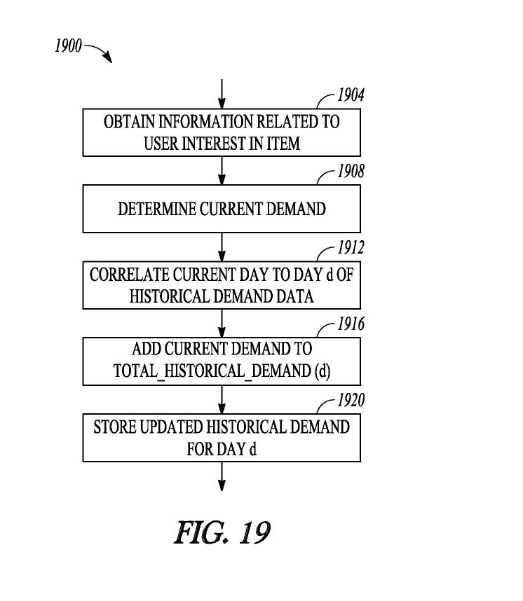

The historical demand processing module 610 maintains historical demand data for one or more items for sale. For example, the historical demand processing module 610 may maintain the historical demand data of FIGS. 7A and 7B, as described more fully below in conjunction with FIG. 19.

The historical inventory processing module 614 maintains historical inventory data for one or more items for sale. For example, the historical inventory processing module 614 may maintain the historical inventory data of FIGS. 8A and 8B.

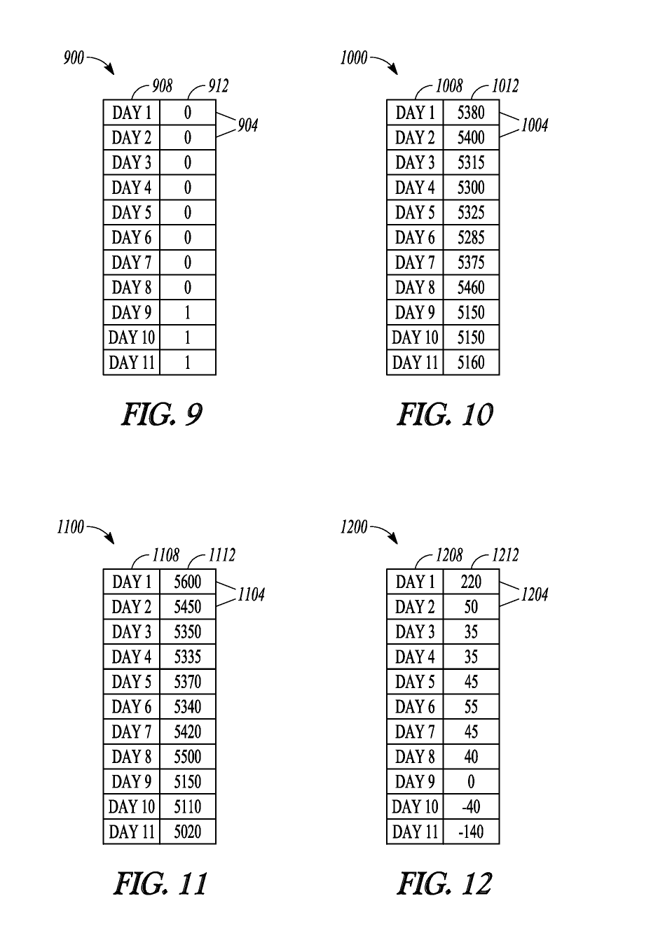

The scheduled inventory processing module 618 maintains information on inventory that has been scheduled for listing during a specified time period. For example, the scheduled inventory processing module 618 may maintain the scheduled inventory data of FIG. 9, as described more fully below in conjunction with FIG. 18.

The demand projection processing module 622 generates projected demand data for an item based, for example, on a current demand for the item and the historical demand data maintained by the historical demand processing module 610, as described more fully below in conjunction with FIGS. 7A, 7B, 10 and 14.

The inventory projection processing module 626 generates a projected inventory data for an item based, for example, on a current inventory of the item and the historical inventory data maintained by the historical inventory processing module 614 and the scheduled inventory processing module 618, as described more fully below in conjunction with FIGS. 8A, 8B, 9, 11 and 15.

The inventory oversupply/shortage processing module 630 projects the inventory oversupply/shortage of an item for a specified time period. For example, the inventory oversupply/shortage processing module 630 may subtract the demand projected by the demand projection processing module 622 from the inventory projected by the inventory projection processing module 626 for each of one or more days to derive the inventory oversupply/shortage for the corresponding day, as described more fully below in conjunction with FIG. 16.

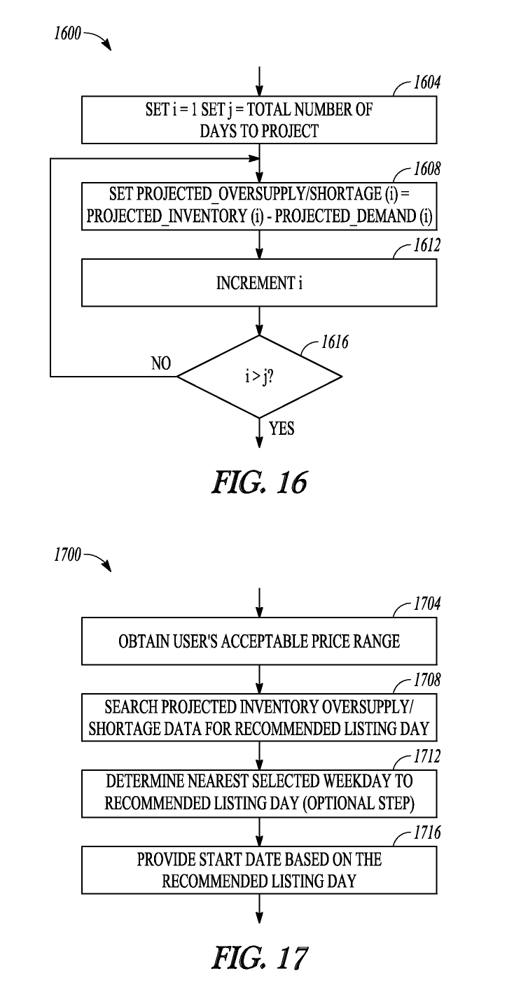

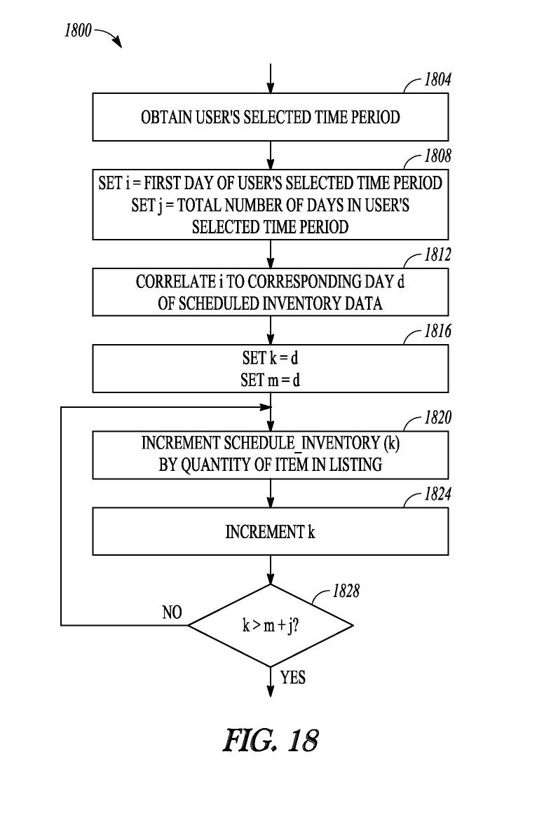

The time period recommendation processing module 634 recommends a time period for listing an item for sale based on, for example, the inventory oversupply/shortage projected by the inventory oversupply/shortage processing module 630, as described more fully below in conjunction with FIG. 17.

FIGS. 7A and 7B show example data structures 700, 750 for generating and maintaining historical demand data for an item, in accordance with an example embodiment. In one example embodiment, the data structure 700 comprises historical demand data for one or more days of a corresponding year and comprises one or more rows 704 where each row 704 contains data corresponding to a particular day, such as a particular day of the corresponding year. For example, the row 704 labeled Day 1 may correspond to Dec. 15, 2010. The data structure 700 further comprises a day identifier 708, a predicted demand 712, a historical demand 716, and a prediction error 720. The predicted demand 712 is the number of units of the item projected to be in demand on the corresponding day and the historical demand 716 is the actual number of units of the item to be in demand on the corresponding day. The prediction error 720 is the difference between the predicted demand 712 and the historical demand 716 for the corresponding day.

In one example embodiment, the data structure 750 comprises historical demand data for one or more years of a corresponding day and comprises one or more rows 754 where each row 754 contains data corresponding to a particular year. For example, the row 754 labeled Year 1 may correspond to the year 2005 for the day December 15 and the row 754 labeled Year 2 may correspond to the year 2006 for the day December 15. The data structure 750 further comprises a year identifier 758, a predicted demand 762, a historical demand 766, and a prediction error 770. The predicted demand 762 is the number of units of the item projected to be in demand during the corresponding year and the historical demand 766 is the actual number of units of the item to be in demand during the corresponding year. The prediction error 770 is the difference between the predicted demand 762 and the historical demand 766 for the corresponding year. In data structure 750, a projection was not conducted from Year 1 through Year 5; thus, the corresponding rows 754 only contain the historical demand 766 for the corresponding year.

FIGS. 8A and 8B show example data structures 800, 850 for generating and maintaining historical inventory data for an item, in accordance with an example embodiment. In one example embodiment, the data structure 800 comprises historical inventory data for one or more days of a corresponding year and comprises one or more rows 804 where each row 804 contains data corresponding to a particular day, such as a particular day of the corresponding year. For example, the row 804 labeled Day 1 may correspond to Dec. 15, 2010. The data structure 800 further comprises a day identifier 808, a predicted inventory 812, a historical inventory 816, and a prediction error 820. The predicted inventory 812 is the number of units of the item projected to be in the available inventory on the corresponding day and the historical inventory 816 is the actual number of units of the item to be in the available inventory on the corresponding day. The prediction error 820 is the difference between the predicted inventory 812 and the historical inventory 816 for the corresponding day.

In one example embodiment, the data structure 850 comprises historical inventory data for one or more years of a corresponding day and comprises one or more rows 854 where each row 854 contains data corresponding to a particular year. For example, the row 854 labeled Year 1 may correspond to the year 2005 for the day December 15 and the row 854 labeled Year 2 may correspond to the year 2006 for the day December 15. The data structure further comprises a year identifier 858, a predicted inventory 862, an historical inventory 866, and a prediction error 870. The predicted inventory 862 is the number of units of the item projected to be in the available inventory during the corresponding year and the historical inventory 866 is the actual number of units of the item to be in the available inventory during the corresponding year. The prediction error 870 is the difference between the predicted inventory 862 and the historical inventory 866 for the corresponding year. In data structure 850, a projection was not conducted from Year 1 through Year 5; thus, the corresponding rows 854 only contain the historical inventory 866 for the corresponding year.

FIG. 9 shows an example data structure 900 for generating and maintaining scheduled inventory data for an item for sale, in accordance with an example embodiment. In one example embodiment, the data structure 900 comprises scheduled inventory data for a future time period and comprises one or more rows 904 where each row 904 contains data corresponding to a particular day, such as a particular day of the year. For example, the row 904 labeled Day 1 may correspond to Dec. 15, 2010. The data structure 900 further comprises a day identifier 908 and a scheduled inventory 912. The scheduled inventory 912 identifies a quantity of a particular item that has been scheduled for sale in one or more item listings on the corresponding day.

FIG. 10 shows an example data structure 1000 for generating and maintaining projected demand data for an item, in accordance with an example embodiment. In one example embodiment, the data structure 1000 comprises the projected demand data for a future time period and comprises one or more rows 1004 where each row 1004 contains the projected demand data for the item on a particular day, such as a particular day of the year. For example, the row 1004 labeled Day 1 may correspond to Dec. 15, 2010. The data structure 1000 further comprises a day identifier 1008 and the projected demand 1012. The projected demand 1012 may be computed, for example, by adjusting the historical demand data of FIGS. 7A and 7B, as described more fully below in conjunction with FIG. 14.

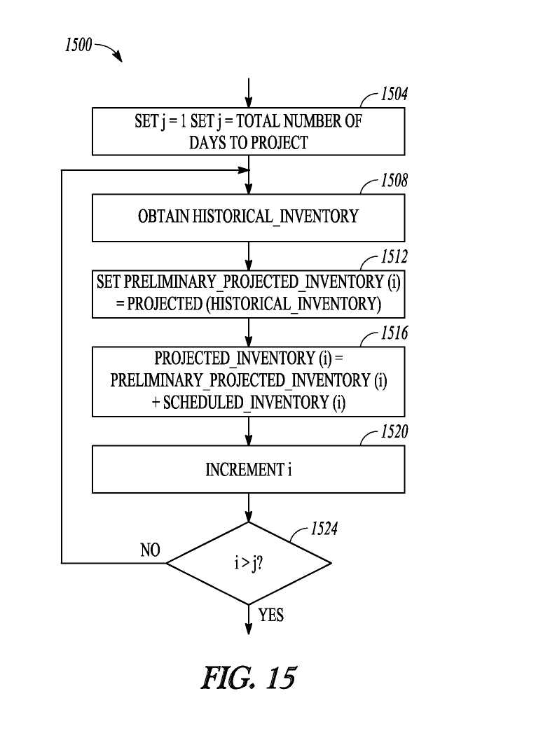

FIG. 11 shows an example data structure 1100 for generating and maintaining projected inventory data for an item, in accordance with an example embodiment. In one example embodiment, the data structure 1100 comprises the projected inventory data for a future time period and comprises one or more rows 1104 where each row 1104 contains the projected inventory data for an item corresponding to a particular day, such as a particular day of the year. For example, the row 1104 labeled Day 1 may correspond to Dec. 15, 2010. The data structure 1100 further comprises a day identifier 1108 and the projected inventory 1112. In one example embodiment, the projected inventory 1112 is computed by adjusting the historical inventory data of FIGS. 8A and 8B. In one example embodiment, the projected inventory 1112 is computed by adjusting the historical inventory data of FIGS. 8A and 8B based on the current inventory and then adding the scheduled inventory 912 of FIG. 9, as described more fully below in conjunction with FIG. 15.

FIG. 12 shows an example data structure 1200 for generating and maintaining projected inventory oversupply/shortage data for an item, in accordance with an example embodiment. In one example embodiment, the data structure 1200 comprises projected inventory oversupply/shortage data for an item for a future time period and comprises one or more rows 1204 where each row 1204 contains the projected inventory oversupply/shortage data for an item corresponding to a particular day, such as a particular day of the year. For example, the row 1204 labeled Day 1 may correspond to Dec. 15, 2010. The data structure 1200 further comprises a day identifier 1208 and the projected inventory oversupply/shortage 1212 for the item. The projected inventory oversupply/shortage 1212 for an item may be computed by subtracting the projected demand 1012 for a selected day from the projected inventory 1112 for the selected day.

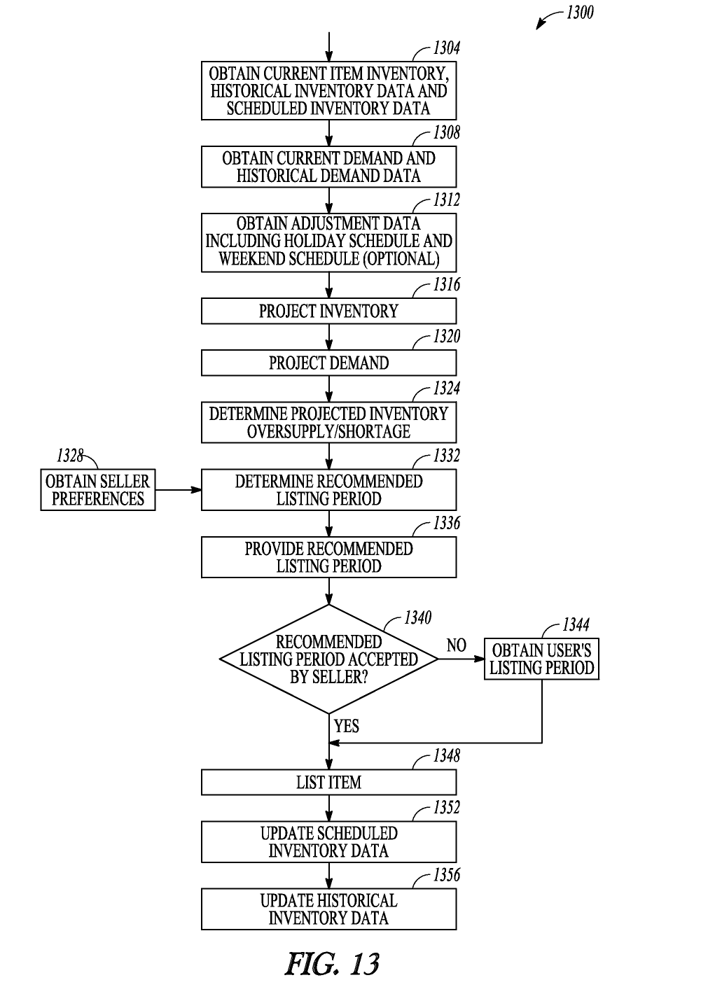

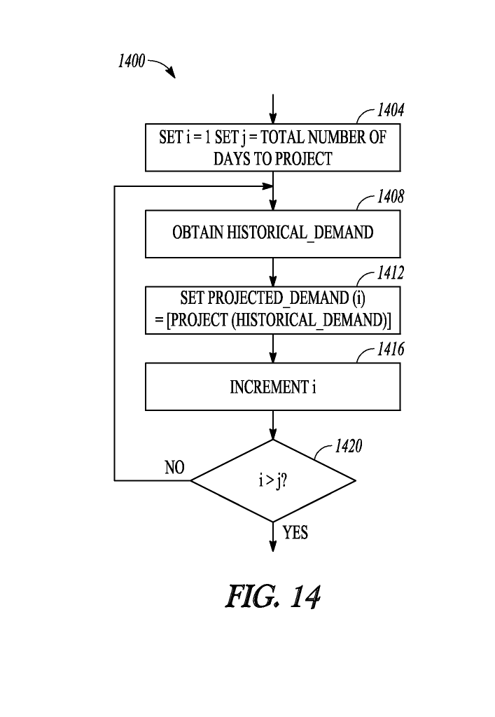

FIG. 13 shows a flowchart for an example method 1300 for controlling an available inventory of an item for sale, in accordance with an example embodiment. In one example embodiment, one or more of the operations of method 1300 may be performed by the listing recommendation processing module 606.

In one example embodiment, the current inventory, the historical inventory 816, 866, and the scheduled inventory 912 may be obtained for an item (operation 1304) and the current demand and the historical demand 716, 766 for the item may be obtained (operation 1308). In one example embodiment, adjustment data, such as a holiday schedule and a weekend schedule may also be obtained (operation 1312).

In one example embodiment, the projected inventory 1112 is determined (operation 1316), as described more fully below in conjunction with FIG. 15, and the projected demand 1012 may be determined (operation 1320), as described more fully below in conjunction with FIG. 14. The projected inventory oversupply/shortage 1212 is then determined based on the projected inventory 1112 and the projected demand 1012 (operation 1324). For example, the projected inventory oversupply/shortage 1212 for an item may be computed by subtracting the projected demand 1012 for a selected day from the projected inventory 1112 for the selected day.

In one example embodiment, one or more seller preferences may be obtained (operation 1328). For example, a seller's rating, a desired price for an item, an acceptable discount offer, and acceptable shipping terms (e.g., free shipping) may be obtained. Based on the projected inventory oversupply/shortage 1212 for an item and, optionally, the obtained seller preferences, one or more preferred listing periods may be determined (operation 1332), as described more fully below in conjunction with FIG. 17. For example, the projected inventory oversupply/shortage 1212 for an item may be searched for the first day, or days, where the demand exceeds the inventory. A recommended listing period(s) beginning on the resulting day(s) may be determined. The recommended listing period may be provided (operation 1336). For example, the recommended listing period may be presented to a seller.

A test may be performed to determine if the recommended listing time period was accepted by the seller (operation 1340). If the recommended listing period was accepted by the seller, the method 1300 may proceed with operation 1348. If the recommended listing period was not accepted by the seller, the seller's chosen listing time period may be obtained (operation 1344).

The item may then be listed using the selected listing time period (i.e., the recommended or the user chosen time period) (operation 1348). The scheduled inventory 912 may be updated based on the selected listing time period, as described more fully below in conjunction with FIG. 18 (operation 1352). For example, the scheduled inventory data corresponding to the selected time period may be incremented by the quantity of the item for sale in the item listing. In one example embodiment, the historical inventory 816, 866 may be updated to incorporate items from item listings that have been recently activated (i.e., listed as available inventory; operation 1356).

FIG. 14 shows a flowchart for an example method 1400 for projecting demand data for an item, in accordance with an example embodiment. In one example embodiment, one or more of the operations of method 1400 may be performed by the demand projection processing module 622.

The demand may be projected using one of a variety of projection techniques. For example, a curve fitting technique, which may involve extrapolation, smoothing, and/or regression analysis, may be used to perform the projection. Curve fitting techniques generate a curve and/or mathematical function that characterizes a series of data points. For example, a curve fitting technique may be used to generate a curve and/or mathematical function that matches the historical demand 716, 766 or the historical inventory 816, 866 of an item and may be used to project future demand or future inventory for the item using the generated curve and/or mathematical function.

In one example embodiment, the following function may be used to project, for example, future demand. In one example, the historical demand 716 may be submitted as a day-to-day data set and the historical demand 766 may be submitted as a year-to-year data set as input data for the function.

function predict_demand(day-to-day data set, year-to-year data set,
date_to_predict)
{

F₁(x) = fit_Curve(day-to-day data set);

// x => day;
//F₁(x) => a function constructed based on the correlation
between day & demand from the day-to-day data set

F₂(x) = fit_Curve(year-to-year data set);

// x => day;
//F₂(x) => a function constructed based on the correlation
between day & demand from the year-to-year data set

Delta₁ = continuous_learning_function(day-to-day data set);

//gives the expected error based on day-to-day data set

Delta₂ = continuous_learning_function(year-to-year data set);

//gives the expected error based on year-to-year data set

return = w₁ * F₁ (date_to_predict) + w₂ * F₂ (date_to_predict) +
w₃ * (−1) * Delta₁ + w₄ * (−1) * Delta₂;

// where w₁, w₂, w₃, w₄ are selected weights.

}

In one example embodiment, the selected weights are set to one. In one example embodiment, the selected weights are a design choice. In one example embodiment, the cited function may comprise a complex function instead of a weighted sum.

Based on the historical demand 716, 766, F₁ (x) may project a previous daily demand of +10 if x is a weekday and a previous weekly demand of +50 if x is a weekend; and F₂ (x) may project a previous year's demand of +500. Delta₁ may project a delta of the daily projection of +/−10 and Delta₂ may project a delta of the weekly projection of +/−100.

In one example, the weight w₁ is set to 0.9 (i.e., more weight given to year-to-year prediction in order to account for special events); the weight w₂ is set to 0.3; the weight w₃ is set to 0.7; and the weight w₄ is set to 0.2. In this example, the prediction for Dec. 25, 2013 would be:

0.9*5000+0.3*1080+0.7*(−1)*(−100)+0.2*(−1)*20=4890

On Dec. 26, 2013, if the actual demand is 4750, the historical demand 716, 766 will be updated with the actual demand and the predicted demand for the corresponding day. Thus, a continuous learning process may be achieved and the historical data set may increase with each day.

In one example embodiment of method 1400, a day index i is initialized to one and a count j of days to project is set to a total number of days to be projected (operation 1404). The historical demand 716, 766 is obtained (operation 1408). A projected demand 1012 for day(i) is then computed based on, for example, the obtained historical demand 716, 766 (operation 1412).

In one example embodiment, the curve fitting technique cited above may be utilized to perform the projection. In one example embodiment, the projected demand 1012 may be computed by multiplying the historical demand 716, 766 for a selected day by a multiplication factor. The multiplication factor may be computed by dividing the count of consumers desiring to purchase the item on the day of the projection computation by the count of consumers desiring to purchase the item on the day corresponding to the day of the projection in the historical demand data.

The day index i is incremented (operation 1416) and a test is performed to determine if the day index i is greater than the count j of projection days (operation 1420). If the day index i is not greater than the count j of projection days, the method 1400 will proceed with operation 1408; otherwise, the method 1400 will end.

FIG. 15 shows a flowchart for an example method 1500 for projecting inventory data for an item, in accordance with an example embodiment. In one example embodiment, one or more of the operations of method 1500 may be performed by the inventory projection processing module 626.

In one example embodiment, a day index i is initialized to one and a count j of projection days is set to a total number of days to be projected (operation 1504). The historical inventory data 816, 866 may be obtained (operation 1508).

A preliminary projected inventory for day i is then computed based on, for example, the obtained historical inventory 816, 866 (operation 1512). For example, as described above in regard to projecting demand data, a curve fitting technique may be utilized to compute the preliminary projected inventory for day i. In one example embodiment, the preliminary projected inventory is computed by multiplying the historical inventory 816, 866 for a selected day by a multiplication factor. The multiplication factor may be computed by dividing the count of items for sale on the day of the projection by the historical inventory for the day corresponding to the day of the projection.

In one example embodiment, the projected inventory for day i is computed by summing the preliminary projected inventory for day i and the scheduled inventory 912 for day i (operation 1516). The day index i is incremented (operation 1520) and a test is performed to determine if the day index i is greater than the count j of projection days (operation 1524). If the day index i is not greater than the count j of projection days, the method 1500 will proceed with operation 1508; otherwise, the method 1500 will end.

FIG. 16 shows a flowchart for an example method 1600 for projecting an inventory oversupply/shortage 1212 of an item, in accordance with an example embodiment. In one example embodiment, one or more of the operations of method 1600 may be performed by the inventory oversupply/shortage processing module 630.

In one example embodiment, a day index i may be initialized to one and a count j of projection days is set to a total number of days to be projected (operation 1604).

A projected inventory oversupply/shortage 1212 for day i is then computed based on, for example, the projected inventory 1112 computed by the inventory projection processing module 626 and the projected demand 1012 computed by the demand projection processing module 622 (operation 1608). For example, the projected inventory oversupply/shortage 1212 for day i may be computed by subtracting the projected demand 1012 for day i from the projected inventory 1112 for day i.

The day index i is incremented (operation 1612) and a test is performed to determine if the day index i is greater than the count j of projection days (operation 1616). If the day index i is not greater than the count j of projection days, the method 1600 will proceed with operation 1608; otherwise, the method 1600 will end.

FIG. 17 shows a flowchart for an example method 1700 for determining a recommended time period for listing an item for sale, in accordance with an example embodiment. In one example embodiment, one or more of the operations of method 1700 may be performed by the time period recommendation processing module 634.

In one example embodiment, a user's acceptable price range and, optionally, other preferences of a user or seller are obtained (operation 1704). The projected inventory oversupply/shortage 1212 may be searched for a day to recommend as a starting listing date (operation 1708). For example, the projected inventory oversupply/shortage 1212 may be searched for a day d where the user's acceptable price is satisfied and where the inventory is projected to be in short supply or where the user's acceptable price is satisfied and there is a projected shortage of the item. In one example embodiment, the projected inventory oversupply/shortage 1212 may be searched for a day d where the user's acceptable price is satisfied and where the inventory is within a predefined range. In one example embodiment, the projected inventory oversupply/shortage 1212 may be searched for a plurality of recommended listing time periods. In one example embodiment, the projected inventory oversupply/shortage 1212 may be searched for a day where the scheduled inventory has the highest average list price, or the highest minimum list price, and the corresponding price may be recommended to the seller.

In one example embodiment, the nearest selected weekday to the day d may be determined (optional operation 1712). For example, the nearest Friday to the day d may be determined. A start date based on day d and/or, optionally, the nearest selected weekday to the day d may be returned as a recommended starting date for the listing of the item (operation 1716).

FIG. 18 shows a flowchart for an example method 1800 for updating scheduled inventory data for an item, in accordance with an example embodiment. In one example embodiment, one or more of the operations of method 1800 may be performed by the scheduled inventory processing module 618.

In one example embodiment, a user's selected time period for listing an item is obtained (operation 1804). A day index i is initialized to a first day of the obtained user's selected time period and a count j of listing days is set to a total number of days in the obtained user's selected time period (operation 1808). The day index i is correlated to a corresponding day d of the scheduled inventory 912 (operation 1812). For example, if the day index i is Thanksgiving Day, then day index i may be correlated to a day d of the scheduled inventory 912 that corresponds to Thanksgiving Day. In one example, if the day index i is Dec. 15, 2010, then day index i may be correlated to a day d of the scheduled inventory 912 that corresponds to Dec. 15, 2010. A variable k and a variable m are then set equal to day d (operation 1816).

The scheduled inventory (k) is incremented by an amount equal to a quantity of the corresponding item in the item listing (operation 1820). For example, if the quantity of the item in the item listing is one, the scheduled_inventory (k) is incremented by one and, if the quantity of the item in the item listing is three, the scheduled_inventory (k) is incremented by three. The variable k is then incremented by one (operation 1824).

A test is performed to determine if the variable k is greater than the sum of the variable m and the count j (operation 1828). If the variable k is not greater than the sum of the variable m and the count j, the method 1800 will proceed with operation 1820; otherwise, the method 1800 will end.

FIG. 19 shows a flowchart for an example method 1900 for updating the historical demand 716, 766 of an item for sale, in accordance with an example embodiment. In one example embodiment, one or more of the operations of method 1900 may be performed by the historical demand processing module 610.

In one example embodiment, information describing users who have indicated an interest in an item is obtained (operation 1904). For example, a count of users searching for the item, bidding on the item, viewing the item, and the like may be obtained.

The obtained information describing users indicating an interest in an item may be analyzed to determine a current demand for the item (operation 1908). The current demand may be, for example, a count of users that have indicated an interest in the item on a selected day, or a count of users that have searched for and/or viewed an item on the selected day.

A current day is correlated to a corresponding day d of the historical demand data (operation 1912). For example, if the current day is Thanksgiving Day, then the current day may be correlated to a day d of the historical demand data that corresponds to Thanksgiving Day.

The historical demand 716, 766 corresponding to day d is incremented by the current demand (operation 1916) and the updated historical demand 716, 766 corresponding to day d is stored (operation 1920).

FIG. 20 shows a representation of an example user interface 2000 for listing a product and/or service, in accordance with an example embodiment. In one example embodiment, the user interface representation 2000 may be utilized by the user device 104 to enable a user to list a product and/or service.

In one example embodiment, a title may be entered in a title field 2004, a condition may be selected in a condition field 2008, and an item description may be entered in an item description field 2012. One or more photos may be added via an add photo icon 2020.

In one example embodiment, a sale format may be selected via format drop-down menu 2024, a listing price may be entered in a listing price field 2028, and a listing duration may be entered in a listing duration field 2032.

In one example embodiment, a recommended start date may be presented to the user via a recommended start date field 2036, as described more fully above. The user may enter the recommended start date or another start date via selected start date field 2040.

Although certain examples are shown and described here, other variations exist and are within the scope of the invention. It will be appreciated, by those of ordinary skill in the art, that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

While the above description focuses on web pages, similar techniques may be utilized in dedicated applications. For example, an ecommerce service may have a web site used by desktop and laptop customers, but also may provide a dedicated application downloadable by users and executable on smartphones and/or tablets. Other mobile devices, such as automobiles and watches, are also possible. In such cases, the dedicated application can utilize the same techniques as a web browser to implement collapsible ads.

### Example Mobile Device

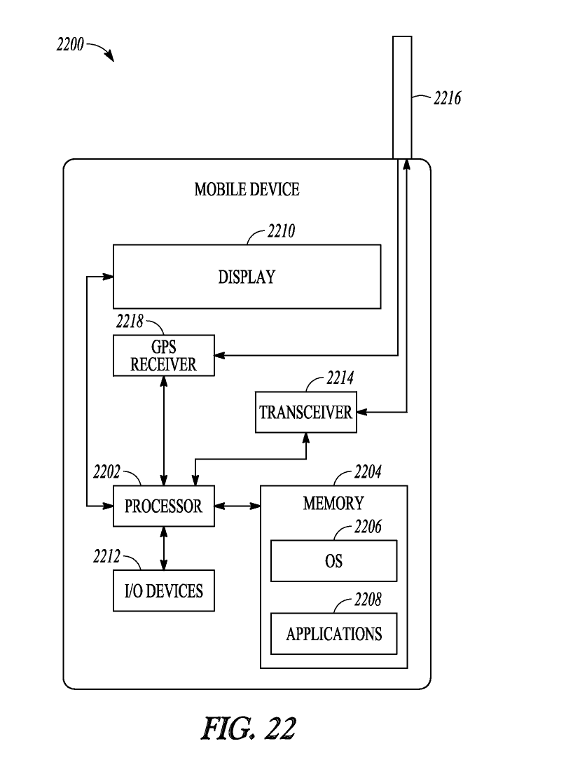

FIG. 22 is a block diagram illustrating a mobile device 2200, according to an example embodiment. The mobile device 2200 may include a processor 2202. The processor 2202 may be any of a variety of different types of commercially available processors suitable for mobile devices (for example, an XScale architecture microprocessor, a microprocessor without interlocked pipeline stages (MIPS) architecture processor, or another type of processor 2202). A memory 2204, such as a random access memory (RAM), a flash memory, or other type of memory, is typically accessible to the processor 2202. The memory 2204 may be adapted to store an operating system (OS) 2206, as well as application programs 2208, such as a mobile location enabled application that may provide LBSs to a user. The processor 2202 may be coupled, either directly or via appropriate intermediary hardware, to a display 2210 and to one or more input/output (I/O) devices 2212, such as a keypad, a touch panel sensor, a microphone, and the like. Similarly, in some embodiments, the processor 2202 may be coupled to a transceiver 2214 that interfaces with an antenna 2216. The transceiver 2214 may be configured to both transmit and receive cellular network signals, wireless data signals, or other types of signals via the antenna 2216, depending on the nature of the mobile device 2200. Further, in some configurations, a GPS receiver 2218 may also make use of the antenna 2216 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

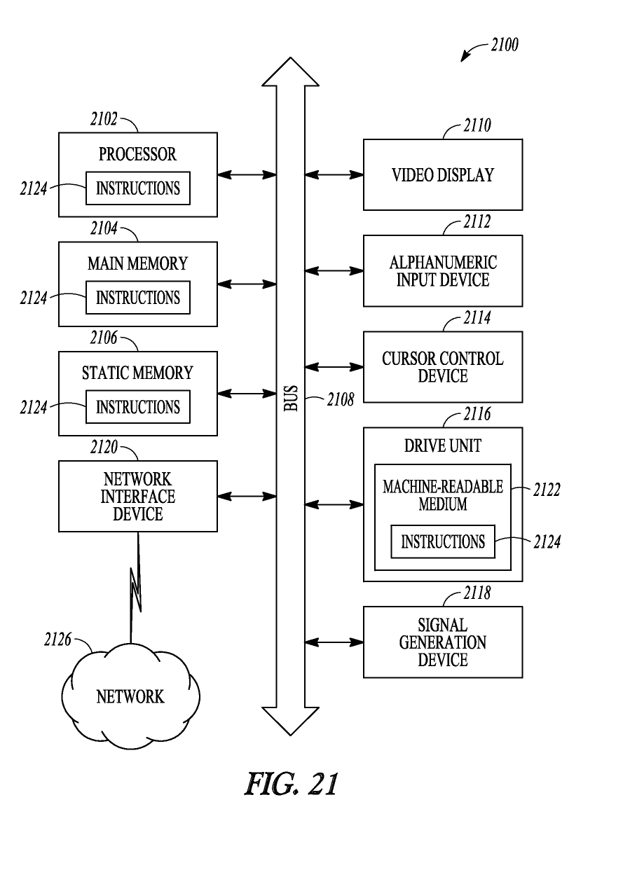

FIG. 21 is a block diagram of a machine within which instructions may be executed for causing the machine to perform any one or more of the methodologies discussed herein. In one example embodiment, the machine may be the example system 300 of FIG. 3 for initiating and conducting a search for products and/or services. In one example embodiment, the machine may be the example apparatus 600 of FIG. 6. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU), a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a user interface (UI) navigation device 2114 (e.g., a mouse), a disk drive unit 2116, a signal generation device 2118 (e.g., a speaker) and a network interface device 2120.

### Machine-Readable Medium

The drive unit 2116 includes a machine-readable medium 2122 on which is stored one or more sets of instructions and data structures (e.g., software) 2124 embodying or utilized by any one or more of the methodologies or functions described herein. The instructions 2124 may also reside, completely or at least partially, within the main memory 2104 and/or within the processor 2102 during execution thereof by the computer system 2100, the main memory 2104 and the processor 2102 also constituting machine-readable media 2122. Instructions 2124 may also reside within the static memory 2106.

While the machine-readable medium 2122 is shown in an example embodiment to be a single medium, the term “machine-readable medium” may include a single medium or multiple media (e.g., a centralized or distributed database, and/or associated caches and servers) that store the one or more instructions or data structures 2124. The term “machine-readable medium” shall also be taken to include any tangible medium that is capable of storing, encoding or carrying instructions 2124 for execution by the machine and that cause the machine to perform any one or more of the methodologies of the present invention, or that is capable of storing, encoding or carrying data structures utilized by or associated with such instructions 2124. The term “machine-readable medium” shall accordingly be taken to include, but not be limited to, solid-state memories, and optical and magnetic media. Specific examples of machine-readable media 2122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 2124 may further be transmitted or received over a communications network 2126 using a transmission medium. The instructions 2124 may be transmitted using the network interface device 2120 and any one of a number of well-known transfer protocols (e.g., hypertext transfer protocol (HTTP)). Examples of communication networks 2126 include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 2124 for execution by the machine, and includes digital or analog communications signals or other intangible media to facilitate communication of such software 2124.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for controlling an inventory of an item for sale, the system comprising:
a demand projection module configured to project a demand for the item;
an inventory projection module configured to project an inventory of the item;
a time period recommendation module configured to determine a recommended future time period for listing the item for sale based on the projected demand and the projected inventory and providing the recommended future time period to a user listing the item on an online marketplace; and
a listing module configured to obtain a user-selected listing time period and generate an item record comprising an item description, the item record being associated with the user-selected listing time period.

2. The system of claim 1, further comprising an inventory oversupply/shortage projection module configured to determine an oversupply/shortage projection of the item.

3. The system of claim 2, wherein the recommended future time period is based on the inventory oversupply/shortage projection of the item.

4. The system of claim 1, wherein the recommended future time period commences on a day where the inventory oversupply/shortage projection of the item is projected to be within a predefined range.

5. The system of claim 1, wherein the recommended future time period is adjusted to commence on a selected day of a week.

6. The system of claim 1, wherein the demand projection is performed by applying a curve fitting technique to historical demand data.

7. The system of claim 1, wherein the inventory projection is performed by applying a curve fitting technique to historical inventory data.

8. The system of claim 1, wherein the inventory projection is based on scheduled inventory data.

9. A method for controlling an inventory of an item for sale, the method comprising:
projecting a demand for the item;
projecting an inventory of the item; and
determining a recommended future time period for listing the item for sale based on the projected demand and the projected inventory and providing the recommended future time period to a user listing the item on an online marketplace;
obtaining a user-selected listing time period; and
generating an item record comprising an item description, the item record being associated with the user-selected listing time period.

10. The method of claim 9, further comprising determining an oversupply/shortage projection of the item.

11. The method of claim 10, wherein the recommended future time period is based on the inventory oversupply/shortage projection of the item.

12. The method of claim 9, wherein the recommended future time period commences on a day where the inventory oversupply/shortage projection of the item is projected to be within a predefined range.

13. The method of claim 9, wherein the recommended future time period is adjusted to commence on a selected day of a week.

14. The method of claim 9, wherein the demand projection is performed by applying a curve fitting technique to historical demand data.

15. The method of claim 9, wherein the inventory projection is performed by applying a curve fitting technique to historical inventory data.

16. The method of claim 9, wherein the inventory projection is based on scheduled inventory data.

17. A non-transitory computer-readable medium embodying instructions that, when executed by a processor, perform operations comprising:
projecting a demand for an item;
projecting an inventory of the item;
determining a recommended future time period for listing the item for sale based on the projected demand and the projected inventory;
providing the recommended future time period to a user listing the item on an online marketplace;
obtaining a user-selected listing time period; and
generating an item record comprising an item description, the item record being associated with the user-selected listing time period.

18. The non-transitory computer-readable medium of claim 17, further comprising instructions that, when executed by the processor, perform an operation of determining an oversupply/shortage projection of the item.

19. The non-transitory computer-readable medium of claim 18, wherein the recommended future time period is based on the inventory oversupply/shortage projection of the item.

20. The non-transitory computer-readable medium of claim 17, wherein the recommended future time period commences on a day where the inventory oversupply/shortage projection of the item is projected to be within a predefined range.
